(19) United States
(12) Patent Application Publication
(10) Pub. No.: US 2003/0236104 A1
(43) Pub. Date: Dec. 25, 2003

(54) Method and device for quickly storing a telephone book in a mobile device

(75) Inventor: Suny Lin, Taoyuan Hsien (TW)

Correspondence Address: BACON & THOMAS, PLLC, 625 SLATERS LANE, FOURTH FLOOR, ALEXANDRIA, VA, 22314

(73) Assignee: GVC Corporation, Taoyuan Hsien (TW)

(21) Appl. No.: 10/214,597

(22) Filed: Aug. 9, 2002

(30) Foreign Application Priority Data
Jun. 21, 2002 (TW) 091113580

(51) Int. Cl. H04B 1/38; G06F 1/00

(52) U.S. Cl. 455/556.1; 708/105

(57) ABSTRACT

The present invention relates to a method and a device for quickly storing a phone book in a mobile device. An optical reader module and an identifier module are provided in the invention to progress a scanning and identification. The method comprises the steps of: pressing a scanning key of the mobile device to start a scanning function; taking an image by using the optical reader module to process the scanning; processing format transformation of the image by using the identifier module and driving an appointed program to edit the data involved in the corresponding image; showing the edited information on a screen; and determining whether the data shown on the screen is being stored.

The method and device for quickly storing a phone book in a mobile device of the present invention have an advantage for more quickly and conveniently storing a phone book than storing it by hand key-in.

### BACKGROUND OF THE INVENTION

In progress with the increasing of a technical level, there are various mobile devices on market. For convenience, most of mobile devices are provided with a phone book for quickly searching a phone number to dial. However, when a new phone list is to be added in the mobile device provided with a phone book, the phone list must be input through a keyboard by various key-in manners such as English and other language words key-ins. Such hand key-in type not only takes time but also is troublesome.

### SUMMARY OF THE INVENTION

An object of the present invention is to provide a method and a device for quickly storing a phone book in a mobile device. Scanning letters or image characterizes the method through a scanner, transforming the scanned letters or image into a format, and then storing the format in a phone book of the mobile device, thereby a phone list storing is completed easily and quickly.

Another object of the present invention is to provide a method and a device for quickly storing a phone book in a mobile device. The method is characterized by scanning letters and image through an optical reader module and transforming the scanned letters and image into a format by using an identifier module to increase accuracy.

### BRIEF DESCRIPTION OF THE DRAWINGS

FIG. 1 is a circuit block diagram showing a device for quickly storing a phone book in a mobile device of a preferred embodiment of the present invention;

FIG. 2 is a flow chart showing a method for quickly storing a phone book in a mobile device of a preferred embodiment of the present invention;

FIG. 3 is a flow chart showing steps from a scanning start to a scanning processing according to a method for quickly storing a phone book in a mobile device of a preferred embodiment of the present invention;

FIG. 4 is a flow chart showing steps from a scanning processing to a scanning stop according to a method for quickly storing a phone book in a mobile device of a preferred embodiment of the present invention during the period of from starting the scanning to stop the scanning;

FIG. 5 is a flow chart showing steps for a continuous scanning according to a method for quickly storing a phone book in a mobile device of a preferred embodiment of the present invention;

FIG. 6 shows a series of pictures appeared on a screen of a mobile device when a method for quickly storing a phone book in a mobile device of the present invention is proceeding; wherein

FIG. 6(a) is a picture showing that a mobile device is turned on. FIG. 6(b) shows a state that a user presses a scanning key and selects to activate a scanning function. FIG. 6(c) is a picture on a screen showing that no vacancy in the memory of the phone book is provided. FIG. 6(d) is a picture on a screen showing that a phone book is allowed to fill in. FIG. 6(e) is a picture on a screen showing that a user is now pressing and holding a scanning key to read and to input data. FIG. 6(f) is a picture on a screen showing that the scanning key is released. FIG. 6(g) is a picture on a screen showing that the user is pressing and holding the scanning key again to read and to input next data. FIG. 6(h) is a picture on a screen showing that a user presses a storing function key to store the scanned data. And, FIG. 6(i) is a picture on a screen showing that a user presses a canceling function key to cancel a data storing action.

FIG. 7 is a schematic view showing a device for quickly storing a phone book in a mobile device of one preferred embodiment of the present invention; and

FIG. 8 is a graph showing the states through movements of a functional key.

### DETAIL DESCRIPTION OF THE INVENTION

The method for quickly storing a phone book in a mobile device of the present invention mainly comprises the steps of: pressing a scanning key on a mobile device to start a scanning function; taking an image by using an optical reader module provided on the mobile device; operating the taken image with a format transforming by using an identifier module; driving an appointed program to edit the information corresponding with the image; showing the edited information on a screen; and determining whether the information shown on the screen is being stored.

More particularly, the method for quickly storing a phone book in a mobile device of the present invention comprises the steps of: pressing a scanning key on a mobile device to start a scanning function; taking an image by using an optical reader module provided on the mobile device; operating the taken image with a format transforming through a memory, a central processing unit (CPU) and an identifier module; driving an appointed program to edit the information corresponding with the image; showing the edited information on a screen; and determining whether the information shown on the screen is being stored.

The present invention also relates to a device for quickly storing a phone book in a mobile device, which comprises an optical reader module for scanning letters or image; a scanning key provided on a keyboard of the mobile device for starting the optical reader module; and an identifier module for operating the image with a format transformation and for driving an appointed program to edit information involved in the corresponding image and displaying it on a screen; thereby a quickly storing phone book in the mobile device is achieved.

In a device for quickly storing a phone book in a mobile device of the present invention, a scanning key can be set in three states of pressing, pressing and holding, and releasing.

In a device for quickly storing a phone book in a mobile device of the present invention, if the scanning key is pressed, the mobile device is activated scanning. If the scanning key is pressed and held, the mobile device proceeds scanning. And, if the scanning key is released, the mobile device stops scanning.

The mobile device can be a cellular telephone, a personal digital assistant (PDA), digital dictionary, and electronic watch and etc.

The present invention will be illustrated by reference to the accompanied drawings. However, those embodiments are only to illustrate the present invention without limiting the scope of the present invention. It is well known that various modification, alternation, and change can be made without departing the scope and spirit of the present invention.

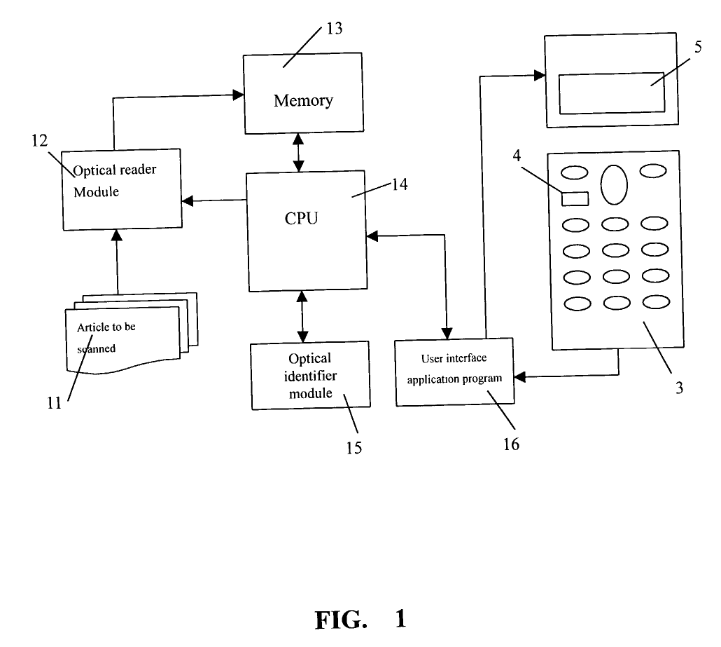

Now refer to FIG. 1, it shows one embodiment of the method and the device for quickly storing a phone book in a mobile device of the present invention. First, the mobile device is turned on. A scanning key 4 on a keyboard 3 is pressed and a signal is transmitted to a central processing unit 14 through a user interface applied program 16 and then a optical reader module 12 is driven to start scanning an article 11 to form an image therein. The scanned image is stored in a memory 13 and then transmitted to the central processing unit 14. In there, the scanned image is subjected to an image format transformation by using an optical identifier module 15 and then an user interface applied program 16 is used to edit an image information. The edited information is displayed on a screen 5 of the mobile device through the central processing unit 14 and the user interface applied program 16.

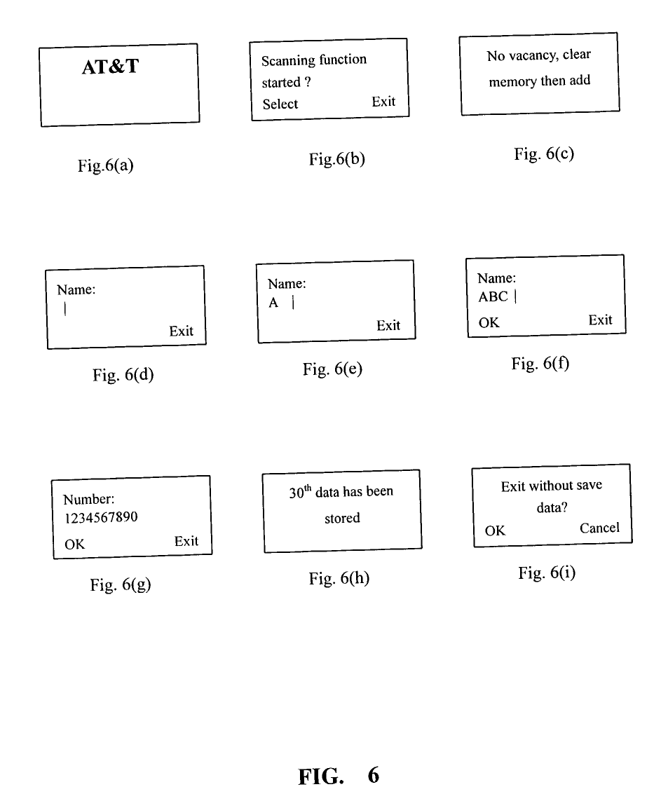

Now refer to FIGS. 2 to 6 illustrating flow charts for carrying out the method for quickly storing a phone book in a mobile device of a preferred embodiment of the present invention. As shown in FIG. 2, when a mobile device is turned on (its corresponding picture is shown as FIG. 6(a), step 21), a user presses a scanning key (its corresponding picture is shown as FIG. 6(b), step 22). The user selects starting a scanning function, the screen displays whether there still has a vacancy in a memory for storing (step 23). If so, the screen displays whether the scanning function is activated (step 24). If so, a scanning function is starting (step 25). If not, go back to the step 21. If the screen shows that there is no vacancy for storing, the screen displays that the memory should be partly cleared if new information is to be input (its corresponding picture is shown in FIG. 6(c), step 26). If not, go back to step 21.

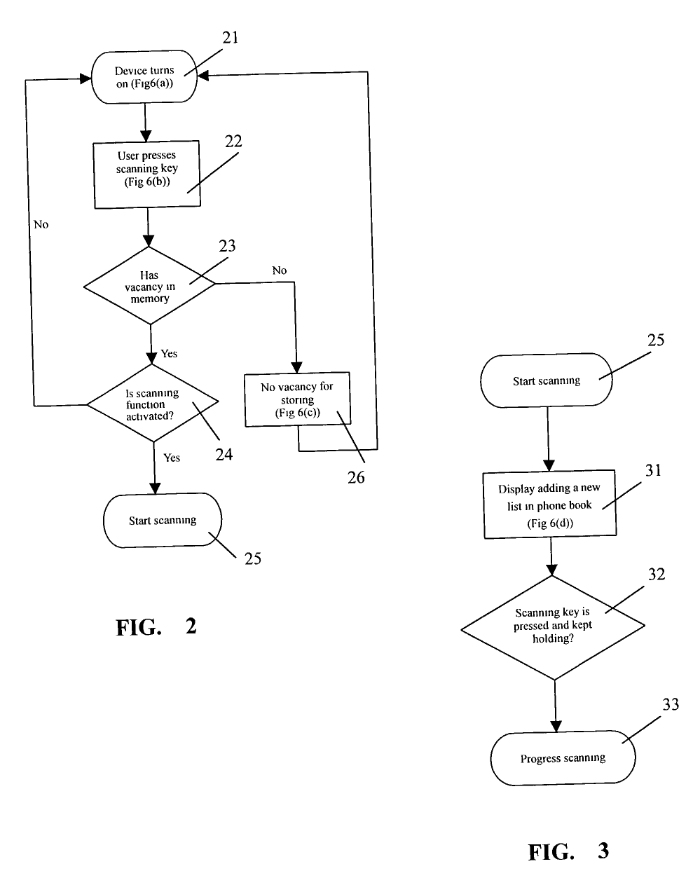

As a scanning function is started (step 25 in the FIG. 2), then refer to FIG. 3. First, the mobile device is at a state that the scanning function is activated and the screen shows adding a new list in phone book (as shown in FIG. 6(d), step 31). The user presses and keeps holding the scanning key (step 32) to proceed the scanning (step 33).

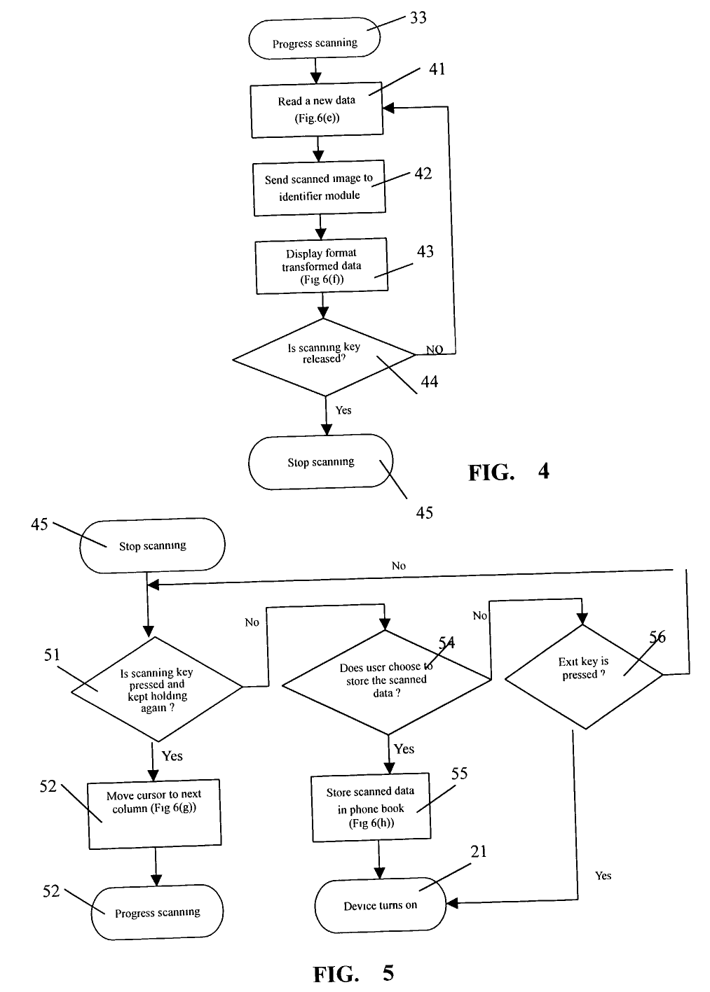

Next refer to FIG. 4, proceed the scanning (step 33), read in a new data (step 41). The scanned image is sent to an identifier module (step 42) to proceed a format transforming and shown on the screen of the mobile device (as shown in FIG. 6(f), step 43). If the scanning key is released after completing the scanning (step 44), the scanning action is stopped (step 45). If the scanning key is still pushed down, the mobile device is back to step 41 to continue the scanning (step 41) and repeat the scanning.

Further, as shown in FIG. 5, after the scanning function is stopped (step 45), if the user presses and keeps holding the scanning key again(step 51), a cursor moves to the next column (as shown in FIG. 6(g), step 52) and a scanning is then proceeding (step 53). If the user releases the scanning key, the scanning function is stopped (step 45), then the screen displays whether the user decides to store the scanned data in the mobile device (step 54). If so, the scanned information is stored in the mobile device (as shown in FIG. 6(h), step 55) and then the mobile device is back to step 21. If the user decides not to store the scanned data in step 54, the screen displays whether exit scanning (as shown in FIG. 6(i), step 56). If yes, the mobile device is back to step 21. If not, the mobile device is back to step 45.

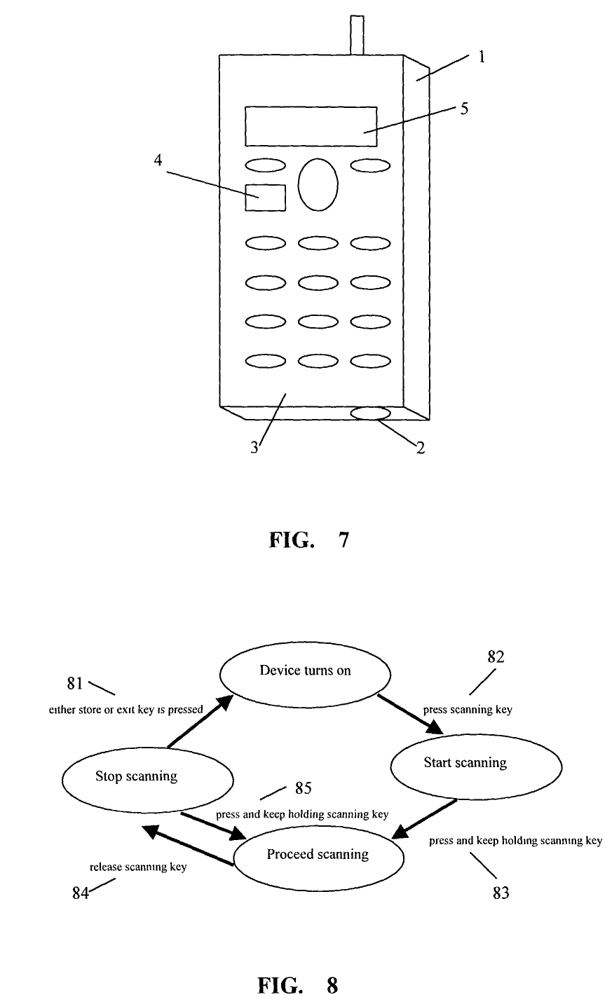

A device for carrying out the method of the present invention is illustrated in FIG. 7. The device comprises a mobile device 1, an optical reader module 2 installed in the mobile device 1, a keyboard 3 for input information, a scanning key 4 disposed on the keyboard 3, and a screen 5 for displaying.

Also as shown in FIG. 8, in the device for quickly storing a phone book in a mobile device of the present invention, when the mobile device is turned on, if a scanning key is pressed (step 82), it means that a scanning function is activated. As the scanning function is activated, if a scanning key is pressed and kept holding (step 83), the mobile device is starting to proceed the scanning. If a scanning key is released (step 84), the scanning function is stopped. At this time, if a scanning key is re-pressed and kept holding, the mobile device is back to proceed scanning. As the scanning function is stopped, if either a storing or exiting key (step 81) is pressed, the mobile device is back to a standby mode.

In the device for quickly storing a phone book in a mobile device of the present invention, for the terms such as “mobile device”, “optic reader module”, “scanning key”, and “screen” are well known to those skilled in the art, a detailed description is omitted here.

Accordingly, a data input by hand key-in is not more used, the method and device for quickly storing a phone book in a mobile device of the present invention have an advantage of quickly and conveniently storing a phone book and possess an industry utility and inventive step.

1. A method for quickly storing a phone book in a mobile device, comprising the steps of: pressing a scanning key on said mobile device to start a scanning function; scanning an image by using an optical reader module installed in said mobile device; operating said taken image with a format transforming by using an identifier module; driving an appointed program to edit the data involved in the corresponding image; showing said edited data on a screen; and determining whether said data shown on the screen is being stored.

2. The method according to claim 1, wherein said scanning key is used for both starting said scanning function and proceeding said scanning.

3. The method according to claim 2, wherein said scanning function is started by pressing said scanning key.

4. The method according to claim 3, wherein said scanning is proceeded by pressing and holding said scanning key.

5. The method according to claim 4, wherein said scanning is stopped by releasing said scanning key.

6. The method according to claim 5, wherein the scanning key is re-pressed and kept holding to re-start the scanning function.

7. The method according to claim 1, further comprising steps of checking whether a space in a memory of said mobile device is available and then determining whether start said scanning function.

8. The method according to claim 1, wherein said step of determining whether n is stored is processed through a function key on the mobile device.

9. A device for quickly storing a phone book in a mobile device, which comprises an optical reader module for scanning letters or image; a scanning key disposed on a keyboard of the mobile device for starting said optical reader module; and an identifier module for proceeding said image with a format transformation and using an appointed program to edit said data involved in said corresponding image and displaying said data on a screen; thereby, a quick phone book storing in said mobile device is achieved.

10. The device according to claim 9, wherein said scanning key is set in three states of pressing, pressing and holding, and releasing.

11. The device according to claim 10, wherein a scanning function is started if said scanning key is pressed; the mobile device is starting to proceed said scanning if a scanning key is pressed and kept holding and said scanning function is stopped if said scanning key is released.
